(19) United States
(12) Patent Application Publication
(10) Pub. No.: US 2026/0134345 A1
(43) Pub. Date: May 14, 2026

(54) Methods and Systems for Generating Synthetic Data

(71) Applicant: Xero Limited, Te Aro, Wellington (NZ)

(72) Inventors: Brendan Law, Te Aro, Wellington (NZ); Tuan Doan, Te Aro, Wellington (NZ); Victor Fedyashov, Te Aro, Wellington (NZ)

(21) Appl. No.: 19/120,053

(22) PCT Filed: Oct. 16, 2023
(86) PCT No.: PCT/NZ2023/050109

§ 371 Date: Apr. 10, 2025

(30) Foreign Application Priority Data
Oct. 17, 2022 (AU) 2022903041

(51) Int. Cl. G06N 20/00; G06Q 20/38

(52) U.S. Cl. CPC G06N 20/00; G06Q 20/38

(57) ABSTRACT

A method comprises retrieving at least one data generation parameter; selecting a recursion pattern; generating a sequence of transaction data points, where each data point comprises a transaction amount and a transaction date, where the transaction amount is generated based on the at least one data generation parameter, and where the transaction date is generated based on the recursion pattern; adding at least one non-recurring transaction data point to the sequence, the non-recurring transaction data point being a transaction data point with a transaction date that does not follow the recursion pattern; and training a machine learning model using the generated sequence.

### TECHNICAL FIELD

Described embodiments relate to methods and systems for generating synthetic data. In particular, described embodiments relate to systems and methods for generating synthetic data to be used to train computer learning models.

### BACKGROUND

Computer learning models can trained by providing the models with datasets related to the problem that the model is to be trained to solve. For example, a computer learning model being trained to predict recurring transactions may use datasets comprising historical transaction data generated during transactions conducted in the past.

However, it can be difficult to obtain appropriate datasets with enough relevant data points to properly train some models. It is therefore sometimes beneficial to use synthetic data rather than historical data when training computer learning models.

It is desired to address or ameliorate some of the disadvantages associated with prior methods and systems for generating synthetic data, or at least to provide a useful alternative thereto.

Any discussion of documents, acts, materials, devices, articles or the like which has been included in the present specification is not to be taken as an admission that any or all of these matters form part of the prior art base or were common general knowledge in the field relevant to the present disclosure as it existed before the priority date of each claim of this application.

Throughout this specification the word “comprise”, or variations such as “comprises” or “comprising”, will be understood to imply the inclusion of a stated element, integer or step, or group of elements, integers or steps, but not the exclusion of any other element, integer or step, or group of elements, integers or steps.

### SUMMARY

Some embodiments relate to a computer-implemented method comprising:
retrieving at least one data generation parameter;
selecting a recursion pattern;
generating a sequence of transaction data points, where each data point comprises a transaction amount and a transaction date, where the transaction amount is generated based on the at least one data generation parameter, and where the transaction date is generated based on the recursion pattern;
adding at least one non-recurring transaction data point to the sequence, the non-recurring transaction data point being a transaction data point with a transaction date that does not follow the recursion pattern; and
training a machine learning model using the generated sequence.

In some embodiments, the at least one data generation parameter comprises a base transaction amount parameter defining a base transaction amount for each transaction data point, and generating a sequence of transaction data points comprises generating the sequence of transaction data points with the transaction amount for each data point being the base transaction amount.

In some embodiments, the at least one data generation parameter comprises a transaction amount variation parameter, and generating a sequence of transaction data points comprises modifying the transaction amount for at least one data point in the sequence based on the transaction amount variation parameter.

In some embodiments, the transaction amount variation parameter defines at least one of a range of values that the transaction amount can take on, a standard deviation for the transaction amount and/or a distribution for the transaction amount.

According to some embodiments, the at least one data generation parameter comprises a recursion variation parameter that defines a range of variations that are allowable for the selected recursion pattern, and generating a sequence of transaction data points comprises modifying the transaction date for at least one data point in the sequence based on the recursion variation parameter.

In some embodiments, the at least one data generation parameter comprises a date distribution parameter that defines a distribution for the transaction dates of the sequence, and generating a sequence of transaction data points comprises modifying the transaction date for at least one data point in the sequence based on the date distribution parameter.

According to some embodiments, the date distribution parameter defines a distribution of the transaction dates based on the days of the week on which they fall.

According to some embodiments, the date distribution parameter defines a distribution of the transaction dates based on the days of the month on which they fall.

In some embodiments, the at least one data generation parameter comprises a data point number parameter specifying a number of transaction data points to generate for the recursion pattern, and generating a sequence of transaction data points comprises generating a number of transaction data points as specified by the parameter.

Some embodiments further comprise randomly deleting at least one transaction data point from the sequence of transaction data points to simulate a missed payment.

Some embodiments further comprise adding the transaction amount associated with the deleted data point to the next data point in the sequence, to simulate a missed payment that was caught up in the next payment.

Some embodiments further comprise labelling each data point with a label corresponding to the selected recursion pattern.

Some embodiments further comprise labelling the at least one non-recurring transaction data point with a label corresponding to a non-recurring transaction.

Some embodiments further comprise determining a number of non-recurring transaction data points to generate based on the at least one data generation parameter.

Some embodiments further comprise determining a distribution for the non-recurring transaction data points to be generated based on the at least one data generation parameter.

Some embodiments further comprise selecting a new recursion pattern and generating a sequence of transaction data points using the new recursion pattern.

In some embodiments, the recursion pattern is selected from weekly, fortnightly and monthly.

Some embodiments further comprise using the trained machine learning model to identify a recursion patterns of a set of transactions, and predicting at least one future transaction based on the recursion pattern.

Some embodiments relate to a computer readable medium storing non-transitory instructions which, when executed by a processor, cause the processor to perform the method of some other embodiments.

Some embodiments relate to a system comprising:
a processor; and
memory storing program code that is accessible and executable by the processor;
wherein when the processor executes the program code, the processor is caused to perform the method of some other embodiments.

### BRIEF DESCRIPTION OF DRAWINGS

FIG. 1 is a schematic diagram of a process for using a capital management platform to predict cash flow of an entity, according to some embodiments;

FIG. 2 is an example screenshot of a visual display provided by the cash flow forecast engine shown in FIG. 1, according to some embodiments;

FIG. 3 is a process flow diagram of a method for predicting a recurring transaction, according to some embodiments;

FIG. 4 is a process flow diagram of a method for training a model to determine recursion patterns, according to some embodiments;

FIG. 5 is a process flow diagram of a method for generating synthetic training data, according to some embodiments;

FIG. 6 is a block diagram depicting an example application framework, according to some embodiments.

FIG. 7 is a block diagram depicting an example hosting infrastructure, according to some embodiments;

FIG. 8 is a block diagram depicting an example data centre system for implementing described embodiments; and

FIG. 9 is a block diagram illustrating an example of a machine arranged to implement one or more described embodiments.

### DESCRIPTION OF EMBODIMENTS

Described embodiments relate to methods and systems for generating synthetic data. In particular, described embodiments relate to systems and methods for generating synthetic data to be used to train computer learning models.

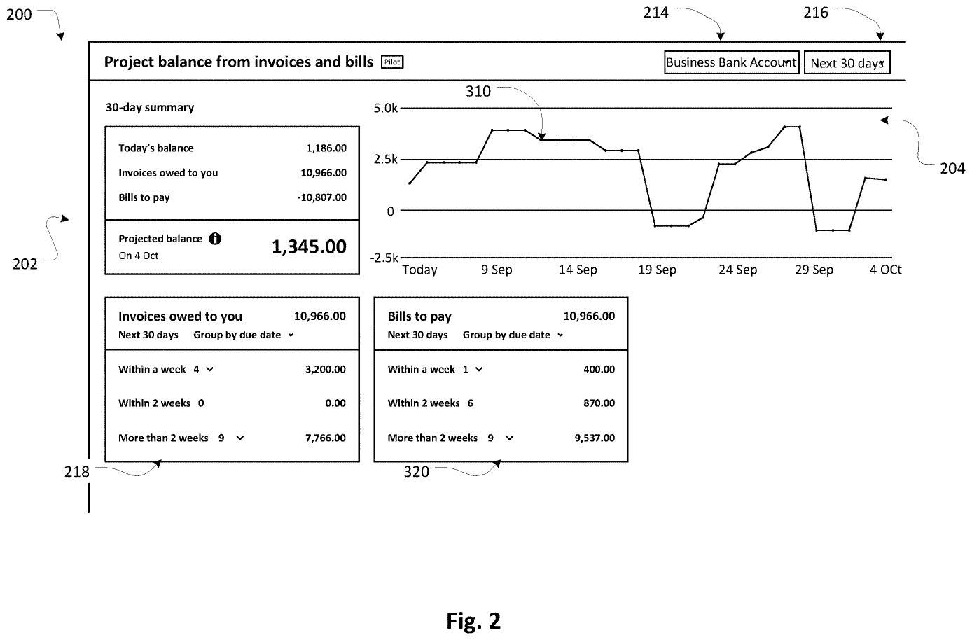

In some embodiments, a capital management platform including a cash flow forecasting platform or tool is provided. The capital management platform is configured to determine predicted capital shortfalls and/or capital surpluses of an entity for a given period of time. The capital management platform may be configured to generate, on a user interface, a visual display of a predicted cash flow of the entity for the period of time based on the predicted capital shortfalls and/or capital surpluses. For example, the visual display may comprise a graphical representation of the predicted cash flow for each day of the time period. An example of such a graphical representation is presented in FIG. 2, and is discussed in more detail below.

The capital management platform may be configured to determine the predicted capital shortfalls and/or capital surpluses at a particular point or day in a given time period based on an assessment of financial data associated with the entity. Financial data associated with an entity may comprise banking data, such as banking data received via a feed from a financial institution, accounting data, payments data, assets related data, transaction data, transaction reconciliation data, bank transaction data, expense data, tax related transaction data, inventory data, invoicing data, payroll data, purchase order data, quote related data or any other accounting entry data for an entity. The financial data may comprise one or more financial records, which may be transaction records in some embodiments. Each financial record may comprise one or more of a transaction amount, a transaction date, one or more due dates and one or more entity identifiers identifying the entities associated with the transaction. For example, financial data relating to an invoice may comprise a transaction amount corresponding to the amount owed, a transaction date corresponding to the date on which the invoice was issued, one or more payment due dates and entity identifiers indicating the invoice issuing entity and the entity under the obligation to pay the invoice. Financial data may also comprise financial records indicating terms of payment and other conditions associated with the financial transaction associated with the financial data.

In some embodiments, the capital management platform may be configured to predict capital shortfalls and/or capital surpluses for a primary entity over a time period based on data relating to historical or current transaction data, or patterns of transaction data. In some embodiments, the capital management platform may be configured to identify recurring transactions from a set of transactions such as a database of transactions and generate a model for predicting future recurring transactions. According to some embodiments, the dataset used to train the model may comprise synthetic transaction data generated by the platform. The model may then be used to by the platform to predict recurring transactions for a given time period, which can then be used by the platform to determine or predict a baseline cash flow forecast.

Examples merely typify possible variations. Unless explicitly stated otherwise, components and functions are optional and may be combined or subdivided, and operations may vary in sequence or be combined or subdivided. In the following description, for purposes of explanation, numerous specific details are set forth to provide a thorough understanding of example embodiments. It will be evident to one skilled in the art, however, that the present subject matter may be practiced without these specific details.

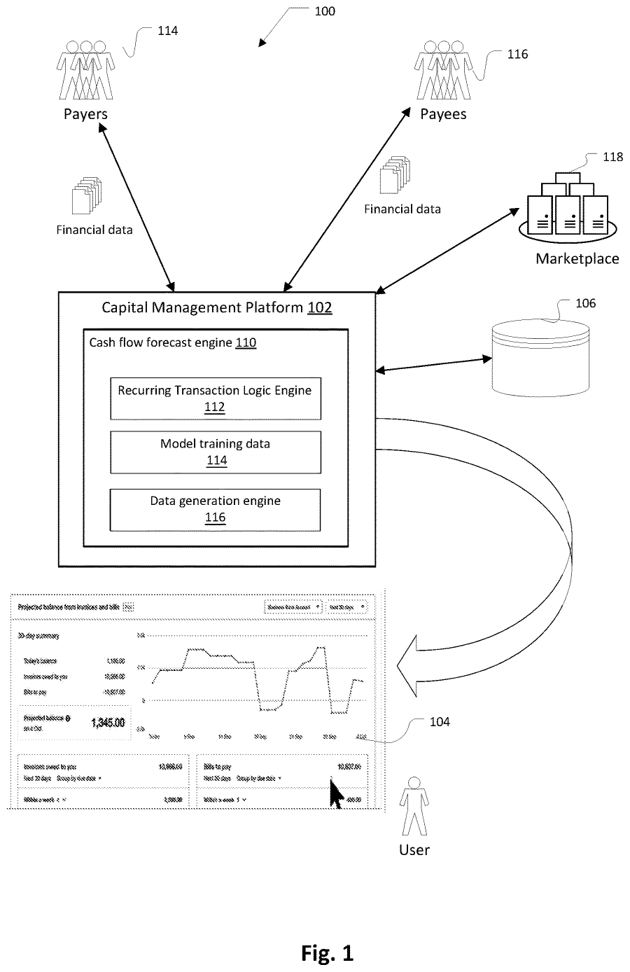

FIG. 1 illustrates a process 100 for using a capital management tool to improve capital management of an entity by forecasting future cash flow of the entity over a predetermined time period. In some embodiments, a capital management platform 102 may be provided to one or more client devices by one or more servers executing program code stored in memory. According to some embodiments, the capital management platform 102 may have the features and functions as described in PCT/AU2020/050924 and/or PCT/AU2020/051184, the entire contents of both of which are incorporated herein by reference. The capital management platform 102 may provide the cash flow forecast engine 110 for use by users of the one or more client devices. In some embodiments, the capital management platform 102 is arranged to communicate with a database 106 comprising financial information associated with a network of entities associated with the capital management platform, and may, for example, include accounting data for transactions between two or more entities. Accordingly, analysis of the data allows for inferences about the business interactions or transactions of those entities. For example, computational analysis of historical patterns of transactions between entities and trading behaviours of entities including responsiveness to financial obligations may be used to predict behaviours of the entities.

Database 106 may comprise one or more databases, data centres or data storage devices, and may comprise cloud storage in some embodiments. In some embodiments, database 106 may be part of an accounting system, such as a cloud based accounting system configured to enable entities to manage their accounting or transactional data. The accounting or transactional data may include data relating to bank account transactions or transfers, invoice data, billings data, expense claim data, historical cash flow data, quotes related data, sales data, purchase order data, receivables data, transaction reconciliation data, balance sheet data, profit and loss data, payroll data, for example. Data in database 106 may enable identification of interrelationships between the primary entity and other entities based on the transactional data. The interrelationships may include relationships that define payment or debt obligations, for example. Based on the interrelationships between the primary entity and other entities, data in database 106 may be used to identify one or more networks of related entities that directly or indirectly transact with each other. Within a network of entities, the financial or cash flow position of one entity may have an impact on the financial or cash flow position of rest of the entities in the network.

The cash flow forecast engine 110 may comprise program code executable by one or more processors of the capital management platform 102. The cash flow forecast engine 110, when executed by the one or more processors of the capital management platform 102, may be configured to predict capital shortfalls and/or capital surpluses of an entity for a given period of time based on information derived from the database 106. For example, the cash flow forecast engine 110 may predict baseline capital shortfalls or baseline capital surpluses based on payment terms of transaction data, such as invoices.

The cash flow forecast engine 110 may comprise a recurring transaction logic engine 112 configured to analyse data relating to recurring transactions, such as recurring bill transactions and recurring invoice transactions undertaken by an entity, and to predict future transactions for the entity. Data relating to transactions includes data relating to bills and invoices that an entity may receive. The recurringtransaction logic engine 112 may employ a predictive model such as a regression model or a trained neural network, for example, and may use historical data relating to previously received bills and invoices in order to predict future transactions that may be recurring during a given period.

The cash flow forecast engine 110 may further comprise a model training engine 114 configured to use training data, such as historical transaction data or synthetic transaction data, to generate models that can be used by recurring transaction logic engine 112 to identify recurring transactions.

The cash flow forecast engine 110 may also comprise a data generation engine 116 configured to generate training data, which may be synthetic transaction data, to be used by model training engine 114 to generate models that can be used by recurring transaction logic engine 112 to identify recurring transactions.

The cash flow forecast engine 110 may be configured to determine a cash flow forecast based on outputs from the recurring transaction logic engine 112. In some embodiments, the cash flow forecast engine 110 may be configured to determine a baseline cash flow based on these outputs and, in some embodiments, to generate a graphical display for displaying the cash flow forecast to a user on a user interface of a client device.

In some embodiments, the cash flow forecast engine 110 may be configured to identify recurring transactions in a database of transactions (for example, a database of synthetic transactions generated by data generation engine 116) and generate a model for predicting future recurring transactions. Predicted recurring transactions for a given period may then be used by the cash flow forecast engine 110 in determining or predicting a baseline cash flow forecast.

The capital management platform 102 may be configured to generate, on a user interface, a visual display of a predicted cash flow of the entity for the period of time based on the predicted capital shortfalls and/or capital surpluses. For example, the visual display may comprise a graphical representation of the predicted cash flow for each day of the time period. An example screenshot of the visual display of the capital management platform 102 is shown in FIG. 2.

Referring now to FIG. 2, there is shown an example screenshot 200 of a visual display of the capital management platform 102. The screenshot 200 illustrates a graphical forecast or prediction relating to cash flow of a primary entity. This may include predictions relating to transactions, bills and/or invoices. Bills may comprise future payment obligations to one or more counterparties or related entities. Invoices may comprise future receivables from one or more counterparties or related entities. Section 202 provides an exemplary 30 day summary of a cash flow forecast for the primary entity, which may include forecasts for the entity's invoices and bills. Section 204 provides a graphical illustration of the cash flow forecast over the next 30 days for the entity. Points below the x-axis on the graph 204 indicate a negative total cash flow forecast at a particular point in time. Points above the x-axis indicate a positive cash flow forecast at a particular point in time. Section 204 comprises a baseline cash flow prediction line 210 indicating the cash flow position of the primary entity over the next 30 days.

Screenshot 200 also illustrates a selectable user input 214 allowing a user to select a particular account for which a cash flow prediction may be performed by the cash flow forecast engine 110. By selecting a different account from the selectable user input 214, a user may visualise a cash flow forecast for a different account for the entity. Screenshot 200 also illustrates another selectable user input 216 that allows a user to vary the duration over which the cash flow forecast engine 110 performs the cash flow prediction. A user may select a different duration of 60 days or 90 days, for example, to view a cash flow prediction over a different timescale.

Screenshot 200 also illustrates some financial data relating to invoices and bills which provides the basis for generation of the graphs in section 204. Section 218 illustrates a summary of financial data relating to invoices for the primary entity. In section 218, the financial data is summarised by the date on which an invoice is due. Section 220 illustrates a summary of financial data relating to bills for the primary entity. In section 220, the financial data is summarised by the date on which a bill is due.

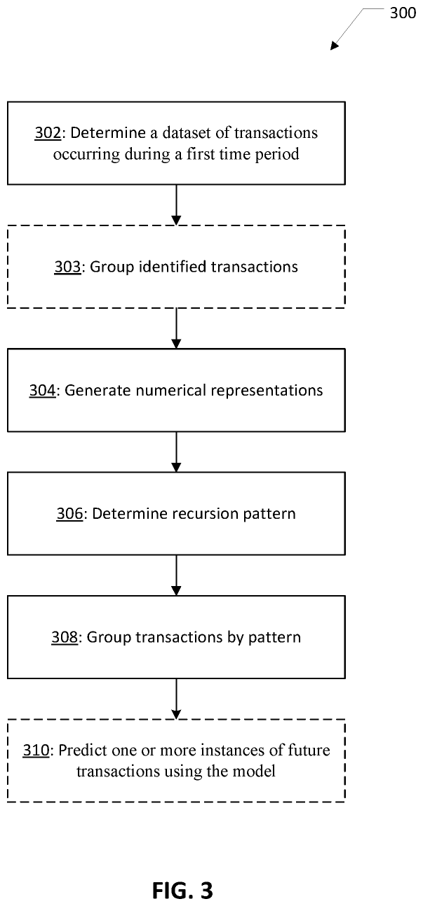

Referring now to FIG. 3, there is shown a process flow for a method 300 of predicting future transactions by identifying recurring transactions in a dataset of transactions. Method 300 may be performed by recurring transaction logic engine 112 when executed by one or more processors of the capital management platform 102. The future transactions may then be used by cash flow forecast engine 110 to determine future cash flow.

At step 302 of method 300, the recurring transaction logic engine 112determines and/or retrieves a dataset of transactions occurring during a first pre-determined time period. According to some embodiments, the pre-determined time period may be a period of time prior to the date on which method 300 is being performed. For example, the time period may be a duration of months prior to the date on which method 300 is being performed, such as a duration of 3 months. The dataset of transactions may be determined or obtained from database 106. Database 106 may comprise financial information associated with a network of entities associated with the capital management platform 102, and may, for example, include accounting data for transactions between two or more entities and one or more accounts associated with each of those entities. The transactions may be associated with one or more entities or contacts or may be associated with a network of entities. Each transaction is associated with corresponding transaction attribute information, such as one or more of the date of the transaction, account name or type, account number, account name, contact name, contact identifier, payment or invoice amount, business registration number (such as ABN, NZBN, UK Companies House number, or the like), and/or contact address.

Optionally at step 303, recurring transaction logic engine 112 may be caused to group the transactions identified at step 302 using one or more grouping criteria. According to some embodiments, the criteria may be selected so as to group transactions that are more likely to be sets of recurring transactions. In some embodiments, this may be done by grouping transactions that are more likely to come from the same source, such as the same biller or invoice issuer. For example, the transactions may be grouped based on one or more of an account name, account number, contact name, transaction type, currency, or bank account number, for example.

Steps 304 to 310 may then be performed for each group of transactions identified in step 303.

At step 304, the recurring transaction logic engine 112 generates a numerical representation of each transaction for a selected group of transactions. According to some embodiments, the numerical representation may be a vector comprising a plurality of numerical values. In some embodiments, the numerical representation may be an embedding of the transaction. The numerical representation may be uninterpretable by humans, but may store data relating to properties of each transaction which may include the transaction date and transaction amount, for example. The numerical representation may capture associations between properties of the transactions within the group of transactions being processed, such as the relationship between transaction dates, for example.

According to some embodiments, the numerical representation may be generated by a machine learning model configured to generate numerical representations of transactions, such as a machine learning model trained using the method described in the Australian Provisional Patent Application 2022903039 titled “Methods and systems for predicting cash flow” and filed on 17 Oct. 2022 by Xero Limited, the entire contents of which are incorporated herein by reference.

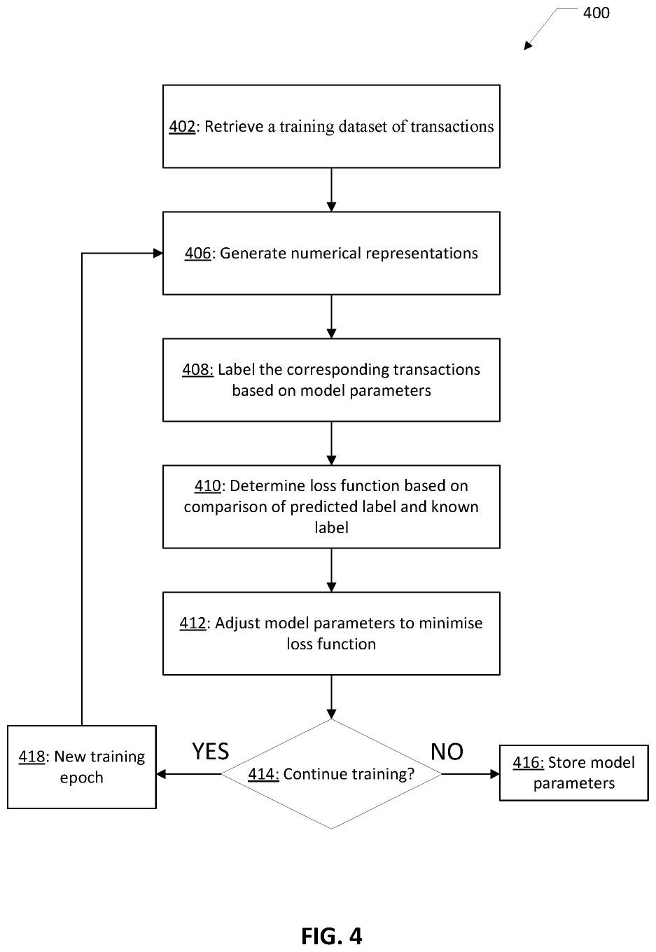

At step 306, the recurring transaction logic engine 112 determines a recursion pattern for each transaction in the group of transactions. According to some embodiments, the recursion pattern may be determined based on the numerical representation of each transaction generated at step 304. According to some embodiments, the recursion pattern may be generated by a machine learning model configured to determine recursion patterns, such as a machine learning model trained using the method described below with reference to FIG. 4.

At step 308, the recurring transaction logic engine 112 groups the transactions by the recursion pattern determined at step 306. According to some embodiments, recurring transaction logic engine 112 may further order the transactions in each group by the transaction date, so that each group comprises an ordered set of recurring transactions.

At optional step 310, the recurring transaction logic engine 112 uses the groups of transactions identified at step 308 to predict one or more instances of future recurring transactions. Recurring transaction logic engine 112 may do this based on the recursion pattern and the last known transaction identified for each group of transactions. For example, for a group of transactions that have been determined to have a “weekly” recursion pattern and where the last transaction occurred on 1 Jan. 2020, cash flow forecast engine 110 may predict a next transaction as occurring on 8 Jan. 2020.

According to some embodiments, the predicted recurring transactions may then be used by cash flow forecast engine 110 to determine a baseline cash flow prediction.

FIG. 4 is a process flow diagram of a method 400 for training a model to identify recursion patterns. Once trained using method 400, a machine learning model can be used to label transactions based on their determined pattern of recursion, and may be used to perform step 306 of method 300, as described above with reference to FIG. 3. The model training engine 114, when executed by one or more processors of the capital management platform 102, may be configured to perform method 400. The model trained using method 400 may be a neural network model in some embodiments.

At step 402, the model training engine 114 retrieves a training dataset of transactions. The training dataset may contain at least one subset of transactions, represented by transaction parameters. For example, each transaction may be represented by at least one of a transaction amount and a transaction date. In some embodiments, the training dataset may include transactions that are both recurring and non-recurring. Each transaction in the dataset may be labelled with an associated recursion pattern. For example, the transactions may be labelled as “weekly”, “fortnightly”, “monthly” or “no pattern”, in some embodiments.

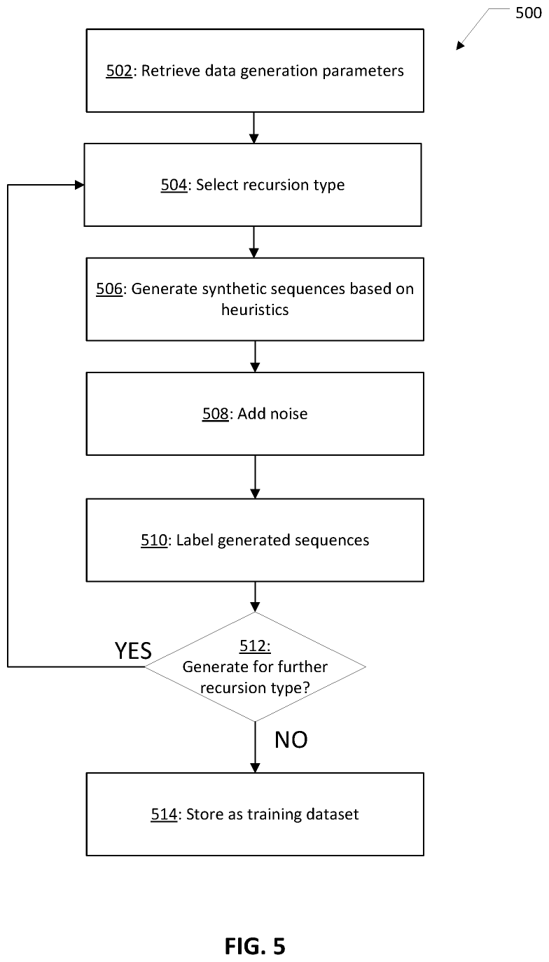

According to some embodiments, the training dataset may include historical transaction data that has been retrieved from database 106. According to some embodiments, the training dataset may include synthetic transaction data generated specifically for training of the model. According to some embodiments, the training dataset may comprise synthetic transaction data generated using the method as described in further detail below with reference to FIG. 5.

At step 406, numerical representations of the retrieved transactions are generated, as described above with reference to step 304 of method 300.

At step 408, the model training engine 114 generates a label or category for each transaction based on the current model parameters, which may be stored in database 106. According to some embodiments, the label or category may describe a recursion pattern of the transaction, such as “weekly”, “fortnightly”, “monthly”, or “no pattern”, for example. In some embodiments, the label or category may be a value or sequence corresponding to a recursion pattern. For example, the label “001” may correspond to a weekly recursion pattern in some embodiments.

The model parameters may control how a transaction is mapped to a recursion pattern. Prior to the first iteration, the model parameters may be set to a default value such as 0 or 1, for example. This may cause the labels generated at step 408 to be relatively random during the initial iterations of method 400. The labels may become more accurate as the model parameters are tuned after multiple iterations of method 400 have been performed.

At step 410, the model training engine 114 determines a loss function by comparing the label generated at step 408 with the known recursion pattern of each transaction.

According to some embodiments, determining the loss function may be used as a manner of penalising the model for making incorrect predictions. A correct prediction, being a prediction that matches the known recursion pattern, may result in a loss function of zero. Any derivation from the target transaction may increase the calculated loss function.

Determining the loss function may comprise determining a categorical loss function. The categorical loss function may include a binary classification loss function or a multi-class classification loss function, and may be used to quantify the difference between a predicted recursion pattern and a known recursion pattern. For example, a cross-entropy loss function may be used in some embodiments.

Where multiple sequences of transactions have been processed, the loss function may comprise the sum of the loss functions for each processed sequence of transactions.

At step 412, the model training engine 114 adjusts or tunes the model parameters to minimise the loss function determined at step 410.

At step 414, the model training engine 114 determines that a training epoch has been completed, and determines whether to continue training the model. According to some embodiments, the model training engine 114 may do this by comparing the completed number of training epochs against a predetermined number of training epochs to complete, to check whether the desired number of training epochs have been performed. In some embodiments, the model training engine 114 may alternatively determine whether to continue training by determining whether the decrease in the loss function for the last one or more sequences of training data have been below a predetermined threshold. As the change to the loss function becomes smaller from one iteration to the next, this may indicate that further training will have a negligible effect on the accuracy of the model.

If the model training engine 114 determines that more training is required, model training engine 114 may proceed to step 418, at which a new training epoch is initiated.

The training dataset may be shuffled in some embodiments, and model training engine 114 continues by executing method 400 from step 406, by re-generating numerical representations for the transactions in the training dataset. If the model training engine 114 determines that no more training is required, model training engine 114 may proceed to step 416, by storing the tuned model parameters for use in determining recursion patterns of transactions, as described above with reference to step 306 of method 300.

FIG. 5 is a process flow diagram of a method 500 for generating synthetic training data that can be used to train a model. According to some embodiments, the data generated by performing method 500 may be synthetic transaction data that can be written to a training dataset as retrieved at step 402 of method 400, described in further detail above with reference to FIG. 4.

According to some embodiments, the data generated by performing method 500 may be used to train a model to identify recursion patterns. Once trained using the data generated by performing method 500, a machine learning model can be used to label transactions based on their determined pattern of recursion, and may be used to perform step 306 of method 300, as described above with reference to FIG. 3. The data generation engine 116, when executed by one or more processors of the capital management platform 102, may be configured to perform method 500.

At step 502, the data generation engine 116 retrieves one or more data generation parameters. The parameters may define the amount of data and/or the type of data to be generated. For example, the data generation parameters may include a data point number parameter defining a number of data points to be generated, where each data point may comprise one or more values. The data generation parameters may further include a data point values parameter defining a number of values per data point to be generated. Where the data to be generated is synthetic transaction data, each data point may correspond to an artificial or simulated transaction, the data point number parameter may define the number of transaction data points to generate. The data point values parameter may define how many values to generate per simulated transaction. For example, in some embodiments, two values may be generated per transaction, which may correspond to a transaction date and a transaction amount. In some embodiments, one or more further values may be generated per transaction, which may include values relating to a payor or payee, such as a payor or payee bank account; payor or payee contact details; transaction type; and/or transaction currency, for example.

According to some embodiments, the data generation parameters may additionally or alternatively include one or more parameters relating to the values to be generated. For example, the parameters may define a range that the values to be generated can take, and/or a distribution of those values.

Where the data to be generated is synthetic transaction data and the data is to include a transaction date, the data generation parameters may include a recursion variation parameter which may define a range of variations that are allowable for each recursion pattern of recurring transactions to be generated. The allowable variations may be different between the recursion types, and may be higher for longer recursion patterns. For example, for a weekly recursion pattern, the allowable variation may be one day, meaning transaction dates can only be generated to be 6, 7 or 8 days apart for each transaction within the pattern. For a monthly recursion pattern, the allowable variation may be greater, and may be 3 in some embodiments, meaning transaction dates may vary up to 3 days within a monthly pattern.

According to some embodiments, the data generation parameters may include a date distribution parameter defining the desired distribution for the transaction date values. This may include a distribution of the days of the week on which the transaction dates should fall, and/or a distribution of the days of the month on which the transactions should fall. For example, according to some embodiments, the data generation parameters may specify that more transaction dates should fall of weekdays than weekends.

Where the data to be generated is synthetic transaction data and the data is to include a transaction amount, the data generation parameters may define one or more of a base transaction amount and a transaction amount variation parameter. The transaction amount variation parameter may define at least one of a range of values that the transaction amount can take on; a standard deviation of the transaction amount values generated for each sequence of recurring transactions, and/or a distribution for the transaction amount values. For example, according to some embodiments the standard deviation may be between 0 and 0.2. In some embodiments, the transaction amounts in each sequence may be generated to follow a normal distribution. In some embodiments, the base transaction amount may be $1000 with an allowable deviation of $100 from that value.

According to some embodiments, the data generation parameters may further define whether missing or catch-up data points are allowed.

Where the data to be generated is synthetic transaction data and the data is to include a transaction date and transaction amount, allowing catch-up transactions may cause the generated data to randomly remove one or more transactions from a series of recurring transactions, and add the transaction amount related to that transaction to the next transaction in the sequence. For example, if weekly recursion type is indicated, the date sequence of 1st, 8th, 15th, 22nd, and 29^{th} may be considered a normal weekly recurring transaction set. Allowing missing transactions to be synthesised may result in one or more transactions being removed from the sequence, such that the generated sequence may actually be 1st, 15th, 22nd, and 29^{th}, for example. Missing transactions may synthesise a situation where a payment does not occur for one or more recursion periods.

Where the data to be generated is synthetic transaction data and the data is to include a transaction amount, allowing missing transactions may cause the generated data to randomly remove one or more transactions from a series of recurring transactions. For example, if weekly recursion type is indicated, the date and amount sequence of 1^{st}, $1000; 8^{th}, $1000; 15^{th}, $1000; 22nd, $1000; and 29^{th}, $1000 may be considered a normal weekly recurring transaction set. Allowing catch-up transactions to be synthesised may result in one or more transactions being removed from the sequence and the related transaction amount being added to the payment amount for the next data point in the sequence, such that the generated sequence may actually be 1^{st}, $1000; 15^{th}, $2000; 22nd, $1000; and 29^{th}, $1000, for example. Missing transactions may synthesise a situation where a payment is skipped for one or more recursion periods, and is made up for by way of a larger payment during the following recursion period.

Other data generation parameters may include a number or percentage of transaction data points to generate per recursion type (which may be higher for shorter recursion types, in some embodiments); a number or percentage of non-recurring transactions to generate as described at step 512; and a distribution for any non-recurring transactions to be generated.

At step 504, the data generation engine 116 selects a first recursion type for a first sequence of generated transactions. According to some embodiments, the recursion type may be selected from a list retrieved at step 502. According to some embodiments, the list may comprise one or more of weekly, fortnightly and monthly recursion types. According to some embodiments, the recursion type may be selected to ensure that a percentage of transaction sequences generated for each recursion types matches a data generation parameter retrieved at step 502.

At step 506, the data generation engine 116 generates at least one synthetic sequence based on the selected recursion type and the generation parameters. According to some embodiments, data generation engine 116 may do this by first generating a ‘perfect’ sequence of data points based on the recursion type, transaction amount and number of transactions as specified by the generation parameters retrieved at step 502. For example, a generated sequence may look like the one shown in Table 1 below:

TABLE 1

| Transaction amount | Transaction date |
|---|---|
| 852.00 | 2018 Feb. 25 |
| 852.00 | 2018 Mar. 4 |
| 852.00 | 2018 Mar. 11 |
| 852.00 | 2018 Mar. 18 |
| 852.00 | 2018 Mar. 25 |

Data generation engine 116 may then adjust the transaction amounts by an allowable amount based on the generation parameters retrieved at step 502. The sequence may become that shown in Table 2 below:

TABLE 2

| Transaction amount | Transaction date |
|---|---|
| 853.00 | 2018 Feb. 25 |
| 831.18 | 2018 Mar. 4 |
| 923.71 | 2018 Mar. 11 |
| 772.36 | 2018 Mar. 18 |
| 881.59 | 2018 Mar. 25 |

Data generation engine 116 may also or alternatively adjust the transaction dates by an allowable amount based on the generation parameters retrieved at step 502. The sequence may become that shown in Table 3 below, where the date of the third transaction in the sequence is shifted by one day:

TABLE 3

| Transaction amount | Transaction date |
|---|---|
| 853.00 | 2018 Feb. 25 |
| 831.18 | 2018 Mar. 4 |
| 923.71 | 2018 Mar. 12 |
| 772.36 | 2018 Mar. 18 |
| 881.59 | 2018 Mar. 25 |

Finally, data generation engine 116 may delete or combine transactions based on the rules defined by the generation parameters retrieved at step 502 for missing and catch-up transactions. The sequence may become that shown in Table 4 below, where the fourth transaction of Table 3 has been missed and the payment amount for the fourth transaction of Table 3 has been added to the last transaction of the sequence:

TABLE 4

| Transaction amount | Transaction date |
|---|---|
| 853.00 | 2018 Feb. 25 |
| 831.18 | 2018 Mar. 4 |
| 923.71 | 2018 Mar. 12 |
| 1653.95 | 2018 Mar. 25 |

By performing the data generation in the manner described, it is possible to trace what variations were made to each transaction when compared to the initial ‘perfect’ sequence. This allows for the ability to reverse the transformations applied to the sequence and uncover the original data points, which may improve the extent to which the synthetic training data can be analysed and understood. This may result in a better ability to evaluate any model which is trained on the generated data.

At step 508, data generation engine 116 adds noise to the generated dataset. The noise may be in the form of adding non-recurring transactions to the set of generated transactions, based on the data generation parameters defining how noise should be added as retrieved at step 502. According to some embodiments, the data generation parameters may specify different amounts of noise to add to each recursion type. For example, more noise may be added to sequences with a weekly recursion type than a monthly recursion type. The amount of noise to add to each recursion type may be determined by analysing actual transaction data to determine which transaction types include more noise in the real world, in some embodiments.

For example, where non-recurring transactions have been added as noise to the weekly sequence generated and shown in Table 4 above, data generation engine 116 may generate the non-recurring transactions shown as the second, fourth, seventh, ninth and tenth transactions shown in Table 5 below:

TABLE 5

| Transaction amount | Transaction date |
|---|---|
| 852.992435 | 2018 Feb. 25 |
| 2000.000000 | 2018 Feb. 26 |
| 831.176822 | 2018 Mar. 4 |
| 50.000000 | 2018 Mar. 4 |
| 923.713511 | 2018 Mar. 11 |
| 772.360295 | 2018 Mar. 18 |
| 300.000000 | 2018 Mar. 22 |
| 881.593448 | 2018 Mar. 25 |
| 1500.000000 | 2018 Mar. 27 |
| 800.000000 | 2018 Mar. 28 |

At step 508, each datapoint in the sequence generated at step 506 may be labelled with the recursion pattern selected at step 504. Any non-recurring transactions may be given a label defining them as non-recurring. For example, taking the transactions of Table 5 and labelling them appropriately may produce the labels shown below in Table 6:

TABLE 6

| Transaction amount | Transaction date | Label |
|---|---|---|
| 852.992435 | 2018 Feb. 25 | Weekly |
| 2000.000000 | 2018 Feb. 26 | Non-recurring |
| 831.176822 | 2018 Mar. 4 | Weekly |
| 50.000000 | 2018 Mar. 4 | Non-recurring |
| 923.713511 | 2018 Mar. 11 | Weekly |
| 772.360295 | 2018 Mar. 18 | Weekly |
| 300.000000 | 2018 Mar. 22 | Non-recurring |
| 881.593448 | 2018 Mar. 25 | Weekly |
| 1500.000000 | 2018 Mar. 27 | Non-recurring |
| 800.000000 | 2018 Mar. 28 | Non-recurring |

At step 512, the data generation engine 116 determines whether data for further recursion types should be generated. Data generation engine 116 may do this by checking the list of recursion types and/or a parameter defining the number of datapoints or sequences to be generated for each recursion type, and determining whether further sequences should be generated. If data generation engine 116 determines that further sequences should be generated, data generation engine 116 returns to step 504 and selects a new recursion type, or a recursion type for which further sequences should be generated.

If data generation engine 116 determines that no further sequences should be generated, data generation engine 116 continues to step 514.

At step 514, the data generation engine 116 stores the generated synthetic transaction data as a training dataset. The dataset may be stored in one or more memory locations of cash flow forecasting platform 102. According to some embodiments, the generated data may be stored ordered by transaction date. According to some embodiments, the generated data may be stored in a random order.

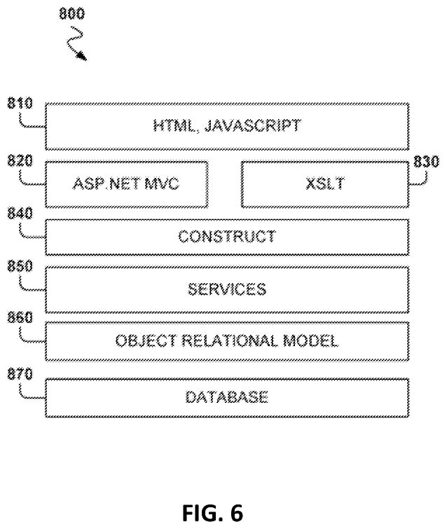

FIG. 6 is a block diagram depicting an example application framework 800, according to some embodiments. The application framework 800 may be an end-to-end web development framework enabling a “software as a service” (SaaS) product. The application framework 800 may include a hypertext markup language (HTML) and/or JavaScript layer 810, ASP .NET Model-View-Controller (MVC) 820, extensible stylesheet language transformations (XSLT) 830, construct 840, services 850, object relational model 860, and database 870.

The HTML and/or JavaScript layer 810 provides client-side functionality, such as user interface (UI) generation, receipt of user input, and communication with a server. The client-side code may be created dynamically by the ASP .NET MVC 820 or the XSLT 830. Alternatively, the client-side code may be statically created or dynamically created using another server-side tool. The ASP .NET MVC 820 and XSLT 830 provide server-side functionality, such as data processing, web page generation, and communication with a client. Other server-side technologies may also be used to interact with the database 870 and create an experience for the user.

The construct 840 provides a conduit through which data is processed and presented to a user. For example, the ASP .NET MVC 820 and XSLT 830 can access the construct 840 to determine the desired format of the data. Based on the construct 840, client-side code for presentation of the data is generated. The generated client-side code and data for presentation is sent to the client, which then presents data. In some example embodiments, when the MLP is invoked to analyze an entry, the MVC website makes an HTTP API call to a Python-based server. Also, the MVC website makes another HTTP API call to the Python-based server to present the suggestions to the user. The services 850 provide reusable tools that can be used by the ASP .NET 820, the XSLT 830, and the construct 840 to access data stored in the database 870. For example, aggregate data generated by calculations operating on raw data stored in the database 870 may be made accessible by the services 850.

The object relational model 860 provides data structures usable by software to manipulate data stored in the database 870. For example, the database 870 may represent a many-to-one relationship by storing multiple rows in a table, with each row having a value in common. By contrast, the software may prefer to access that data as an array, where the array is a member of an object corresponding to the common value. Accordingly, the object relational model 860 may convert the multiple rows to an array when the software accesses them and perform the reverse conversion when the data is stored.

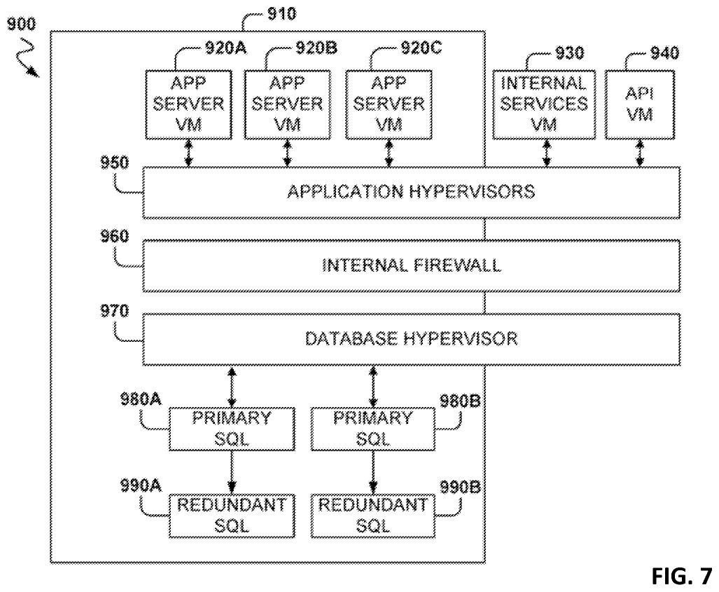

FIG. 7 is a block diagram depicting an example hosting infrastructure 900, according to some embodiments. The platform 600 may be implemented using one or more pods 910. Each pod 910 includes application server virtual machines (VMs) 920 (shown as application server virtual machines 920A-920C in FIG. 7) that are specific to the pod 910 as well as application server virtual machines that are shared between pods 910 (e.g., internal services VM 930 and application protocol interface VM 940). The application server virtual machines 920-940 communicate with clients and third-party applications via a web interface or an API. The application server virtual machines 920-940 are monitored by application hypervisors 950. In some example embodiments, the application server virtual machines 920A-920C and the API VM 940 are publicly accessible while the internal services VM 930 is not accessible by machines outside of the hosting infrastructure 900. The app server VMs 920A-920C may provide end-user services via an application or web interface. The internal services VM 930 may provide back-end tools to the app server VMs 920A-920C, monitoring tools to the application hypervisors 950, or other internal services. The API VM 940 may provide a programmatic interface to third parties. Using the programmatic interface, the third parties can build additional tools that rely on the features provided by the pod 910. An internal firewall 960 ensures that only approved communications are allowed between the database hypervisor 970 and the publicly accessible virtual machines 920-940. The database hypervisor 970 monitors the primary SQL servers 980A and 980B and the redundant SQL servers 990A and 990B. The virtual machines 920-940 can be implemented using Windows 8008 R2, Windows 8012, or another operating system. The support servers can be shared across multiple pods 910. The application hypervisors 950, internal firewall 960, and database hypervisor 970 may span multiple pods 910 within a data centre.

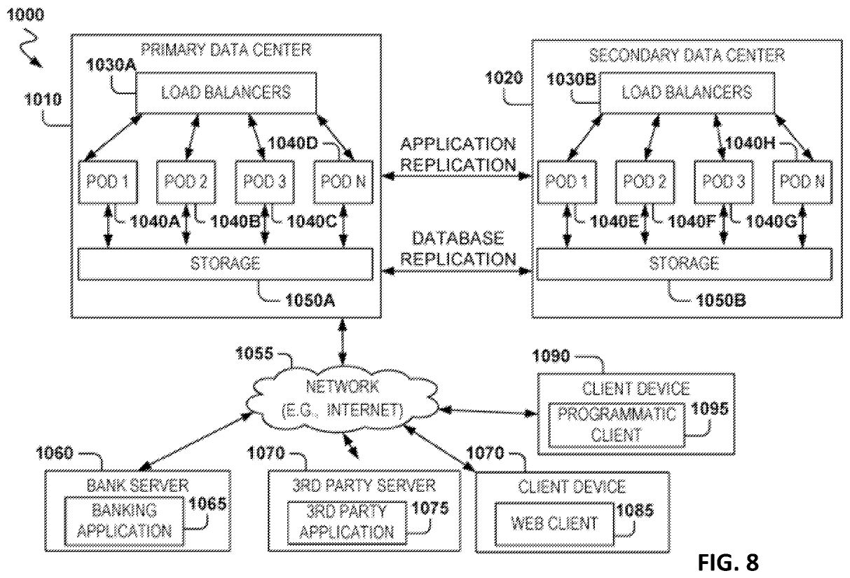

FIG. 8 is a block diagram depicting an example data centre system 1000 for implementing embodiments. The primary data centre 1010 services customer requests and is replicated to the secondary data centre 1020. The secondary data centre 1020 may be brought online to serve customer requests in case of a fault in the primary data centre 1010. The primary data centre 1010 communicates over a network 1055 with bank server 1060, third party server 1070, client device 1070, and client device 1090. The bank server provides banking data (e.g., via a banking application 1065). The third-party server 1070 is running third party application 1075. Client devices 1080 and 1090 interact with the primary data centre 1010 using web client 1085 and programmatic client 1095, respectively. Within each data centre 1010 and 1020, a plurality of pods, such as the pod 910 of FIG. 7, are shown. The primary data centre 1010 is shown containing pods 1040a-1040d. The secondary data centre 1020 is shown containing pods 1040e-1040h. The applications running on the pods of the primary data centre 1010 are replicated to the pods of the secondary data centre 1020. For example, EMC replication (provided by EMC Corporation) in combination with VMWare site recovery manager (SRM) may be used for the application layer replication. The database layer handles replication between a storage layer 1050a of the primary data centre and a storage layer 1050b of the secondary data centre. Database replication provides database consistency and the ability to ensure that all databases are at the same point in time. The data centres 1010 and 1020 use load balancers 1030a and 1030b, respectively, to balance the load on the pods within each data centre. The bank server 1060 interacts with the primary data centre 1010 to provide bank records for bank accounts of the client. For example, the client may provide account credentials to the primary data centre 1010, which the primary data centre 1010 uses to gain access to the account information of the client.

The bank server 1060 can provide the banking records to the primary data centre 1010 for later reconciliation by the client using the client device 1080 or 1090. The third-party server 1070 may interact with the primary data centre 1010 and the client device 1080 or 1090 to provide additional features to a user of the client device 1080 or 1090.

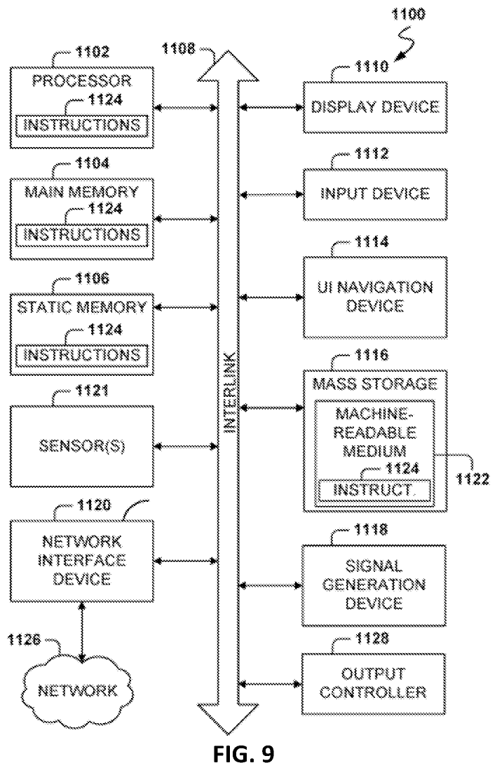

FIG. 9 is a block diagram illustrating an example of a machine upon which one or more example embodiments may be implemented. In alternative embodiments, the machine 1100 may operate as a standalone device or may be connected (e.g., networked) to other machines. In a networked deployment, the machine 1100 may operate in the capacity of a server machine, a client machine, or both in server-client network environments. In an example, the machine 1100 may act as a peer machine in peer-to-peer (P2P) (or other distributed) network environment. The machine 1100 may be a personal computer (PC), a tablet PC, a set-top box (STB), a laptop, a mobile telephone, a web appliance, a network router, switch or bridge, or any machine capable of executing instructions (sequential or otherwise) that specify actions to be taken by that machine. Further, while only a single machine 1100 is illustrated, the term “machine” shall also be taken to include any collection of machines that individually or jointly execute a set (or multiple sets) of instructions to perform any one or more of the methodologies discussed herein, such as cloud computing, SaaS, or other computer cluster configurations.

Examples, as described herein, may include, or may operate by, logic or a number of components, or mechanisms. Circuitry is a collection of circuits implemented in tangible entities that include hardware (e.g., simple circuits, gates, logic, etc.). Circuitry membership may be flexible over time and underlying hardware variability. Circuitries include members that may, alone or in combination, perform specified operations when operating. In an example, hardware of the circuitry may be immutably designed to carry out a specific operation (e.g., hardwired). In an example, the hardware of the circuitry may include variably connected physical components (e.g., execution units, transistors, simple circuits, etc.) including a computer-readable medium physically modified (e.g., magnetically, electrically, moveable placement of invariant massed particles, etc.) to encode instructions of the specific operation.

In connecting the physical components, the underlying electrical properties of a hardware constituent are changed, for example, from an insulator to a conductor or vice versa. The instructions enable embedded hardware (e.g., the execution units or a loading mechanism) to create members of the circuitry in hardware via the variable connections to carry out portions of the specific operation when in operation. Accordingly, the computer-readable medium is communicatively coupled to the other components of the circuitry when the device is operating. In an example, any of the physical components may be used in more than one member of more than one circuitry. For example, under operation, execution units may be used in a first circuit of a first circuitry at one point in time and reused by a second circuit in the first circuitry, or by a third circuit in a second circuitry, at a different time.

The machine (e.g., computer system) 1100 may include a hardware processor 1102 (e.g., a central processing unit (CPU), a graphics processing unit (GPU), a hardware processor core, or any combination thereof), a main memory 1104, and a static memory 1106, some or all of which may communicate with each other via an interlink (e.g., bus) 1108. The machine 1100 may further include a display device 1110, an alphanumeric input device 1112 (e.g., a keyboard), and a UI navigation device 1114 (e.g., a mouse). In an example, the display device 1110, input device 1112, and UI navigation device 1114 may be a touch screen display. The machine 1100 may additionally include a mass storage device (e.g., drive unit) 1116, a signal generation device 1118 (e.g., a speaker), a network interface device 1120, and one or more sensors 1121, such as a global positioning system (GPS) sensor, compass, accelerometer, or another sensor. The machine 1100 may include an output controller 1128, such as a serial (e.g., universal serial bus (USB), parallel, or other wired or wireless (e.g., infrared (IR), near field communication (NFC), etc.) connection to communicate or control one or more peripheral devices (e.g., a printer, card reader, etc.).

The storage device 1116 may include a machine-readable medium 1122 on which is stored one or more sets of data structures or instructions 1124 (e.g., software) embodying or utilized by any one or more of the techniques or functions described herein. The instructions 1124 may also reside, completely or at least partially, within the main memory 1104, within static memory 1106, or within the hardware processor 1102 during execution thereof by the machine 1100. In an example, one or any combination of the hardware processor 1102, the main memory 1104, the static memory 1106, or the storage device 1116 may constitute machine-readable media.

While the machine-readable medium 1122 is illustrated as a single medium, the term “machine-readable medium” may include a single medium or multiple media (e.g., a centralized or distributed database, and/or associated caches and servers) configured to store the one or more instructions 1124.

The term “machine-readable medium” may include any medium that is capable of storing, encoding, or carrying instructions 1124 for execution by the machine 1100 and that cause the machine 1100 to perform any one or more of the techniques of the present disclosure, or that is capable of storing, encoding or carrying data structures used by or associated with such instructions 1124. Non-limiting machine-readable medium examples may include solid-state memories, and optical and magnetic media. In an example, a massed machine-readable medium comprises a machine-readable medium 1122 with a plurality of particles having invariant (e.g., rest) mass. Accordingly, massed machine-readable media are not transitory propagating signals. Specific examples of massed machine-readable media may include: non-volatile memory, such as semiconductor memory devices (e.g., Electrically Programmable Read-Only

Memory (EPROM), Electrically Erasable Programmable Read-Only Memory (EEPROM)) and flash memory devices; magnetic disks, such as internal hard disks and removable disks; magneto-optical disks; and CD-ROM and DVD-ROM disks. The instructions 1124 may further be transmitted or received over a communications network 1126 using a transmission medium via the network interface device 1120 utilizing any one of a number of transfer protocols (e.g., frame relay, internet protocol (IP), transmission control protocol (TCP), user datagram protocol (UDP), hypertext transfer protocol (HTTP), etc.). Example communication networks may include a local area network (LAN), a wide area network (WAN), a packet data network (e.g., the Internet), mobile telephone networks (e.g., cellular networks), Plain Old Telephone (POTS) networks, and wireless data networks (e.g., Institute of Electrical and Electronics Engineers (IEEE) 1102.11 family of standards known as Wi-Fi®, IEEE 1102.16 family of standards known as WiMax®), IEEE 1102.15.4 family of standards, peer-to-peer (P2P) networks, among others. In an example, the network interface device 1120 may include one or more physical jacks (e.g., Ethernet, coaxial, or phone jacks) or one or more antennas to connect to the communications network 1126.

In an example, the network interface device 1120 may include a plurality of antennas to wirelessly communicate using at least one of single-input multiple-output (SIMO), multiple-input multiple-output (MIMO), or multiple-input single-output (MISO) techniques. The term “transmission medium” shall be taken to include any intangible medium that is capable of storing, encoding or carrying instructions 1124 for execution by the machine 1100, and includes digital or analog communications signals or other intangible medium to facilitate communication of such software.

Throughout this specification, plural instances may implement components, operations, or structures described as a single instance. Although individual operations of one or more methods are illustrated and described as separate operations, one or more of the individual operations may be performed concurrently, and nothing requires that the operations be performed in the order illustrated. Structures and functionality presented as separate components in example configurations may be implemented as a combined structure or component. Similarly, structures and functionality presented as a single component may be implemented as separate components. These and other variations, modifications, additions, and improvements fall within the scope of the subject matter herein. The embodiments illustrated herein are described in sufficient detail to enable those skilled in the art to practice the teachings disclosed. Other embodiments may be used and derived therefrom, such that structural and logical substitutions and changes may be made without departing from the scope of this disclosure. The Detailed Description, therefore, is not to be taken in a limiting sense, and the scope of various embodiments is defined only by the appended claims, along with the full range of equivalents to which such claims are entitled.

As used herein, the term “or” may be construed in either an inclusive or exclusive sense. Moreover, plural instances may be provided for resources, operations, or structures described herein as a single instance. Additionally, boundaries between various resources, operations, modules, engines, and data stores are somewhat arbitrary, and particular operations are illustrated in a context of specific illustrative configurations. Other allocations of functionality are envisioned and may fall within a scope of various embodiments of the present disclosure. In general, structures and functionality presented as separate resources in the example configurations may be implemented as a combined structure or resource. Similarly, structures and functionality presented as a single resource may be implemented as separate resources. These and other variations, modifications, additions, and improvements fall within a scope of embodiments of the present disclosure as represented by the appended claims. The specification and drawings are, accordingly, to be regarded in an illustrative rather than a restrictive sense.

It will be appreciated by persons skilled in the art that numerous variations and/or modifications may be made to the above-described embodiments, without departing from the broad general scope of the present disclosure. The present embodiments are, therefore, to be considered in all respects as illustrative and not restrictive.

1. A computer-implemented method comprising:
retrieving at least one data generation parameter;
selecting a recursion pattern;
generating a sequence of transaction data points, where each data point comprises a transaction amount and a transaction date, where the transaction amount is generated based on the at least one data generation parameter, and where the transaction date is generated based on the recursion pattern;
adding at least one non-recurring transaction data point to the sequence, the non-recurring transaction data point being a transaction data point with a transaction date that does not follow the recursion pattern; and
training a machine learning model using the generated sequence.

2. The method of claim 1, wherein the at least one data generation parameter comprises a base transaction amount parameter defining a base transaction amount for each transaction data point, and generating a sequence of transaction data points comprises generating the sequence of transaction data points with the transaction amount for each data point being the base transaction amount.

3. The method of claim 2, wherein the at least one data generation parameter comprises a transaction amount variation parameter, and generating a sequence of transaction data points comprises modifying the transaction amount for at least one data point in the sequence based on the transaction amount variation parameter.

4. The method of claim 3, wherein the transaction amount variation parameter defines at least one of a range of values that the transaction amount can take on, a standard deviation for the transaction amount and/or a distribution for the transaction amount.

5. The method of claim 1, wherein the at least one data generation parameter comprises a recursion variation parameter that defines a range of variations that are allowable for the selected recursion pattern, and generating a sequence of transaction data points comprises modifying the transaction date for at least one data point in the sequence based on the recursion variation parameter.

6. The method of claim 5, wherein the at least one data generation parameter comprises a date distribution parameter that defines a distribution for the transaction dates of the sequence, and generating a sequence of transaction data points comprises modifying the transaction date for at least one data point in the sequence based on the date distribution parameter.

7. The method of claim 6, wherein the date distribution parameter defines a distribution of the transaction dates based on days of a week on which they fall.

8. The method of claim 6, wherein the date distribution parameter defines a distribution of the transaction dates based on days of a month on which they fall.

9. The method of claim 1, wherein the at least one data generation parameter comprises a data point number parameter specifying a number of transaction data points to generate for the recursion pattern, and generating a sequence of transaction data points comprises generating a number of transaction data points as specified by the parameter.

10. The method of claim 1, further comprising randomly deleting at least one transaction data point from the sequence of transaction data points to simulate a missed payment.

11. The method of claim 10, further comprising adding the transaction amount associated with the deleted data point to a next data point in the sequence, to simulate a missed payment that was caught up in the next payment.

12. The method of claim 1, further comprising labelling each data point with a label corresponding to the selected recursion pattern.

13. The method of claim 1, further comprising labelling the at least one non-recurring transaction data point with a label corresponding to a non-recurring transaction.

14. The method of claim 1, further comprising determining a number of non-recurring transaction data points to generate based on the at least one data generation parameter.

15. The method of claim 1, further comprising determining a distribution for the non-recurring transaction data points to be generated based on the at least one data generation parameter.

16. The method of claim 1, further comprising selecting a new recursion pattern and generating a sequence of transaction data points using the new recursion pattern.

17. The method of claim 1, wherein the recursion pattern is selected from weekly, fortnightly and monthly.

18. The method of claim 1, further comprising using the trained machine learning model to identify a recursion patterns of a set of transactions, and predicting at least one future transaction based on the recursion pattern.

19. A computer readable medium storing non-transitory instructions which, when executed by a processor, cause the processor to perform operations including:
retrieving at least one data generation parameter;
selecting a recursion pattern;
generating a sequence of transaction data points, where each data point comprises a transaction amount and a transaction date, where the transaction amount is generated based on the at least one data generation parameter, and where the transaction date is generated based on the recursion pattern;
adding at least one non-recurring transaction data point to the sequence, the non-recurring transaction data point being a transaction data point with a transaction date that does not follow the recursion pattern; and
training a machine learning model using a generated sequence of claim 1.

20. A system comprising:
a processor; and
memory storing program code that is accessible and executable by the processor;
wherein when the processor executes the program code, the processor is caused to perform operations including:
retrieving at least one data generation parameter;
selecting a recursion pattern;
generating a sequence of transaction data points, where each data point comprises a transaction amount and a transaction date, where the transaction amount is generated based on the at least one data generation parameter, and where the transaction date is generated based on the recursion pattern;
adding at least one non-recurring transaction data point to the sequence, the non-recurring transaction data point being a transaction data point with a transaction date that does not follow the recursion pattern; and
training a machine learning model using a generated sequence of claim 1.
